(19) United States
(12) Patent Application Publication
(10) Pub. No.: US 2026/0216650 A1
(43) Pub. Date: Jul. 30, 2026

(54) A MULTIFUNCTIONAL CATALYST SYSTEM

(71) Applicant: DINEX A/S, Middelfart (DK)

(72) Inventors: Andreina MORENO, Middelfart (DK); Kauko KALLINEN, Middelfart (DK); Alexander CHERNYSHEV, Middelfart (DK)

(73) Assignee: DINEX A/S, Middelfart (DK)

(21) Appl. No.: 19/138,285

(22) PCT Filed: Dec. 12, 2023
(86) PCT No.: PCT/EP2023/085282

§ 371 Date: Jun. 12, 2025

(30) Foreign Application Priority Data
Dec. 14, 2022 (EP) 22213507.1

(51) Int. Cl. B01D 53/94; B01J 23/46; B01J 35/00; B01J 35/57; F01N 3/10; F01N 3/28; F02B 43/10

(52) U.S. Cl. CPC B01D 53/9477; B01D 53/9436; B01D 53/945; B01J 23/464; B01J 35/19; B01J 35/57; F01N 3/101; F01N 3/106; F01N 3/2828; F02B 43/10; B01D 2255/1021; B01D 2255/1023; B01D 2255/1025; B01D 2255/9032; B01D 2255/904; B01D 2255/9155; B01D 2257/302; B01D 2257/404; B01D 2257/406; B01D 2257/502; B01D 2257/7025; B01D 2258/018; F01N 2370/04; F01N 2510/068; F02B 2043/103

(57) ABSTRACT

A multifunctional catalyst system for reducing harmful exhaust gas emissions from an exhaust gas stream of a stoichiometrically operated engine, which includes a) a coating including a sulphur oxide and phosphorus trap (SPT) on a first substrate, b) a three-way catalyst (TWC) on a second substrate, and c) a selective ammonia oxidation catalyst (SAOC) on a third substrate. The first and second substrate are different, avoiding overlap between the SPT and the TWC. The SPT is positioned upstream from the TWC. The ammonia oxidation catalyst is positioned downstream from the TWC. The multifunctional catalyst system is adapted for positioning downstream from the stoichiometrically operated engine and is adapted to be in fluid communication with the exhaust gas stream. The SPT is 10-50 vol % of the total TWC volume, and the SAOC is 10-50 vol % of the total TWC volume.

### FIELD

The present invention relates to the field of catalytic systems for stoichiometric positive ignition engines running on natural gas, biogas, liquified natural gas or Bio-LNG, containing sulphur oxides (SOx) and phosphorus (P) trap (SPT), a three-way catalyst (TWC), and a selective ammonia oxidation catalyst (SAOC). The invention describes the composition of the catalytic system as well its utilization.

### BACKGROUND

It is well known that regardless of the fuel used in the internal combustion engines, the combustion is not complete. In the case of hydrocarbon fuels, such incomplete combustion together with a high temperature in the cylinders causing oxidation of air nitrogen by oxygen leads to contamination of exhaust gas by carbon monoxide (CO), unburned hydrocarbons (HC), nitrogen oxides (NOx), and particulate matter (PM). These pollutants are harmful to the environment and humans. In order to reduce their amounts and consequently to improve the air quality, the emission of the pollutants from stationary and mobile sources is restricted by the legislation limits assigned by national and international authorities. To cope with the limitations, different strategies are applied, including improving the fuel-air mixing, strict lambda control, etc. However, since the limitations have become more and more stringent over the years, engine improvements solely are generally not enough to bring the emission of pollutants below the limits. This makes the use of an exhaust aftertreatment system containing heterogeneous catalyst unavoidable.

Light passenger cars have been based on stoichiometric Otto engines, where it is easy to remove CO, HC and NOx on TWCs in stoichiometric conditions. Later, rich burning heavier vehicles were introduced (for example natural gas fueled busses) which originally have been based for diesel engines, where the air/fuel ratio is clearly lean (excess of oxygen). There are several benefits when using natural gas as a fuel.

In the case of gasoline or compressed natural gas (CNG) stoichiometric engines which feature is an oscillation of lambda value around the stoichiometric point λ=1, a heterogeneous catalyst is represented by a three-way catalyst (TWC). TWC simultaneously treats CO, HC, and NOx. Lambda oscillations are inevitably important for the TWC since in rich conditions (λ<1, less oxygen than needed for complete oxidation of fuel) catalytic NOx reduction is maximized while in lean conditions (λ>1, more oxygen than needed for complete oxidation of fuel) catalytic HC and CO oxidation to CO2 and water is facilitated. As natural gas is nearly sulfur free it results low/no SOx emissions and in lean-burn conditions lower NOx emissions can be achieved compared to diesel engines while in stoichiometric conditions NOx emissions can be higher due to higher operating temperatures. Also, particulate mass emissions are much lower and only minor black carbon emissions are formed from natural gas fueled engines compared to diesel engines. In addition, CO2 emissions are also lower compared to diesel due to the higher H/C ratio as NG is mainly consist of methane.

The implementation of the TWC technology started in the late 1970s, and since that time the composition of the catalysts is evolving following the development of materials and their costs. However, the main components of the TWCs remain similar. Thus, TWC is a multicomponent mixture coated on the metallic or ceramic substrate (washcoat). The typical components of this mixture are a carrier, oxygen storage material, adhesion agent, and platinum group metals (PGMs) such as Pt, Pd and Rh (the six platinum-group metals are ruthenium, rhodium, palladium, osmium, iridium, and platinum). With the passing of time this basic composition has become more sophisticated by the introduction of dopants in the OSC materials as well as other promoters and stabilizing agents which has extended the base properties of surface area, oxygen mobility and hampered sintering. The extension and improvement of these properties has the objective of ensuring that the precious group metals which are the key active compounds in the conversion of CO, HC, and NOx into less harmful CO₂, N₂, and water remain active for as long as possible.

The biggest challenge in natural gas engines has been methane slip as it is the most difficult hydrocarbon to convert and therefore emissions can be high. In stoichiometric applications also methane can be converted by TWC. Because of the inertness of methane high loadings have been used in TWCs and that has made the price of the catalyst high, especially when PGM prices are at high level. Catalysts to convert methane are based on palladium, which is the best PGM to convert methane, in addition, small amount of rhodium has been used to improve NOx conversion. Due to the high price of the TWC there are examinations going on how to get methane converting catalyst active with lower use of PGMs. A variety of structures such as perovskites, spinels and other mixed oxides with or without PGMs have been tried. Also, the potential way to reduce PGM costs is to replace part of Pd and/or Rh by Pt which price is significantly lower, however this approach requires caution as the threshold for Methane oxidation is largely dependent on appropriate PGM loadings. While it is possible to reduce metal loadings to a great degree, durability becomes a problem after hydrothermal and poisoning conditions.

Besides the regulation of the main pollutants (CO, HC, and NOx), the emission limits starting from EUVI also restrict the concentration of ammonia (NH3) in the exhaust gas. Maximum 10 ppm is allowed over the world harmonized transient teste cycle (WHTC). In stoichiometric operating natural gas fueled engines raw emission does not contain ammonia. Ammonia is produced in the TWC through the reaction of existing hydrogen in raw exhaust gas or hydrogen which is formed on the catalyst surface via the water gas shift or steam reforming reaction. Hydrogen amount in the exhaust is also dependent on the engine calibration how near the lambda=1 engine is operating as in the rich phases more hydrogen is formed to the exhaust gas. The amount of ammonia formed in the TWC significantly depends on the catalyst's composition, PGMs loading, and ratio, degree of aging, etc. To comply with the emission regulation starting from EUVI, selective oxidation of NH₃ to N₂ is necessary. Ammonia formation on the TWC and its amount downstream can be controlled either chemically by formulating the TWC to minimize ammonia formation or separately with additional selective ammonia oxidation catalyst which can be integrated into the TWC or separately assembled after TWC.

During working time, TWCs performance gradually decreases due to thermal and chemical deactivation. Thermal deactivation occurs because of the typically elevated temperatures of the stoichiometric combustion or during a misfire event. High temperature causes sintering of the noble metal particles which means that finely dispersed particles lose their active surface. Via washcoat sintering (collapsing of the pores) some PGM particles can get buried inside the pores and therefore not in use anymore. At higher temperatures, PGM compounds can react with a high surface area carrier to form inactive tertiary-oxides (e.g. aluminates with γ-alumina) in an irreversible process permanently deactivating the catalyst. Sophisticated engine management and selection of durable raw materials for the catalyst are the only strategies allowing to cope with the thermal deactivation of TWC.

Chemical deactivation of TWC, also known as poisoning, occurs because of the interaction of the catalyst with the foreign materials originating from the fuel or the lubrication oil. Such materials called catalytic poisons interact with the TWC impairing its performance. Poisoning can be selective or nonselective. During selective poisoning, a catalyst poison compound reacts directly with the active site of the TWC, decreasing its activity or selectivity for a specific reaction, which can lead to permanent deactivation. Nonselective poisoning, which is also called fouling or masking, represents a process where the poison materials form a physical deposit on the surface of the washcoat.

Many TWC catalytic poisons are known depending on the composition of fuels and lubrication oils and impurities in them, the most common being: Pb, Hg, Cd, S, P, Ca, Zn and K. Among them, S and P (in oxide forms) are the most abundant, and the accumulated weight of them can reach several percent of the total washcoat weight during the lifetime of the catalyst drastically decreasing its performance.

### SUMMARY

In the current work, we present an integrated system, which combines all the components (SPT, TWC, and SAOC) as well as methods of its preparation and utilization.

The present invention solves many of the problems with the prior art as disclosed above in the Background section.

In a first aspect the present invention relates to a multifunctional catalyst system for reducing harmful exhaust gas emissions from an exhaust gas stream of a stoichiometrically operated engine, the system comprising:
a) a coating comprising a sulphur oxide and phosphorus trap (SPT) on a first substrate,
b) a three-way catalyst (TWC) on a second substrate, and
c) a selective ammonia oxidation catalyst (SAOC) on a third substrate.
   wherein the SPT is positioned upstream from the TWC while the ammonia oxidation catalyst is positioned downstream from the TWC and the multifunctional catalyst system is adapted for positioning downstream from the stoichiometrically operated engine, which multifunctional catalyst system is adapted to be in fluid communication with the exhaust gas stream.

In an embodiment the first, second and third substrate are different substrates.

In a further embodiment the second and third substrate is the same substrate, and the first substrate is different.

In a further embodiment the SPT is present in an amount of 10-50 vol % of the total TWC volume. Typically, 20-40 vol % of the total TWC volume. Preferably, 25-35 vol % of the total TWC volume.

In a still further embodiment, the SAOC is present in an amount of 10-50 vol % of the total TWC volume. Typically, 20-40 vol % of the total TWC volume. Preferably, 25-35 vol % of the total TWC volume.

In a further embodiment the TWC comprises at least one of Pt, Pd, and Rh. In an embodiment the TWC consist of Pt, Pd, and Rh. In another embodiment the TWC consist of Pt and Pd. In a still further embodiment, the TWC consist of Pd and Rh. In a further embodiment the total coating amount in grams per liter washcoating (g/l) is from 50 g/l to 400 g/l.

In a still further embodiment the TWC comprises a Pt/Pd ratio (wt %/wt %) of lower than 6, preferably 4 or lower than 4. In a further embodiment the TWC comprises a Pt/Pd ratio (wt %/wt %) of 4 or lower than 4 combined with minimum 0.05 g Rh/liter washcoat.

In a still further embodiment, the SPT comprises at least one of Cu, Mn, and Ce, such as a) Mn, b) Mn and Ce, c) Mn and Cu, or d) Mn and Ce and Cu. In a further embodiment the total coating amount in grams per liter washcoating (g/l) is from 50 g/l to 400 g/l.

In a further embodiment the SPT further comprises at least one of Pt and Pd. In a still further embodiment, the SPT further comprises both of Pt and Pd.

In another embodiment the SPT is free of any one of the platinum group metals, such as Pt, Pd, and Rh.

In a further embodiment the SAOC comprises at least one of Fe, Cu, Sc, Y, La, Ce, Pr, Nd, Ti, Zr and Hf. Preferably, the SAOC is selectively converting ammonia to N₂, keeping ammonium below 10 ppm after SAOC treatment. In a still further embodiment, the SAOC comprises at least one of Pt and Pd. In a further embodiment the SAOC is free of any one of the platinum group metals, such as Pt, Pd, and Rh.

In a further embodiment the first, second and/or third substrate is selected from a ceramic or metallic honeycomb monolith, such as a flow-through or wall-flow substrate.

In a further embodiment the stoichiometrically operated engine is a natural gas or biogas engine, such as an engine using CNG, LNG, Bio-CNG and Bio-LNG as fuel.

In a second aspect the present invention relates to a method to reduce harmful exhaust gas emission from stoichiometrically operated engines comprising use of a multifunctional catalyst system according to any one of the above first aspect or embodiments of the first aspect of the present invention.

In an embodiment the stoichiometrically operated engine is a natural gas or biogas engine, such as an engine using CNG, LNG, Bio-CNG and Bio-LNG as fuel.

In a third aspect the present invention relates to use of the catalyst system of any one of the above first aspect or embodiments of the first aspect of the present invention, to reduce harmful exhaust gas emission from stoichiometrically operated engines, such as a stoichiometrically operated engine using natural gas or biogas as fuel.

In a fourth aspect the present invention relates to an exhaust gas treatment system comprising the catalyst system of any one of the above first aspect or embodiments of the first aspect of the present invention.

In a fifth aspect the present invention relates to a multifunctional catalyst system for reducing harmful exhaust gas emissions from an exhaust gas stream of a stoichiometrically operated engine, the system comprising a three-way catalyst (TWC) on a substrate, and the multifunctional catalyst system is adapted for positioning downstream from the stoichiometrically operated engine, which multifunctional catalyst system is adapted to be in fluid communication with the exhaust gas stream, wherein the TWC comprises Rh, Pt and Pd, and wherein the Pt/Pd ratio (wt %/wt %) is 4 or lower than 4 combined with minimum 0.05 g Rh/liter washcoat.

In an embodiment of the fifth aspect, the Pt, Pd, Rh total content is 0.01-5.00 wt-%, preferably 0.05-3.00 wt-% in the washcoat (coating).

In a further embodiment the washcoat comprising Pt, Pd, Rh is 50-400 g/l, preferably 200-300 g/liter washcoat.

Further objects and advantages of the present invention will appear from the following description, and claims.

### BRIEF DESCRIPTION OF DRAWINGS

FIG. 1-7 illustrates tested and preferred embodiments of the invention.

FIG. 1 shows investigation of trapping activity of aged SPC.

FIG. 2 shows the result of an accelerated poisoning protocol aimed at stimulating the cumulative P content expected from a field aged TWC.

FIG. 3 shows the emission of CO, NOx, and CH₄, and the formation of NH₃ below the Euro VI limit, where TWC functionality is coated on the ceramic honeycomb.

FIG. 4 shows the emission of CO, NOx, and CH₄, and the formation of NH₃ below the Euro VI limit, where TWC functionality is coated on the ceramic honeycomb monolith.

FIG. 5 shows the emission of CO, NOx, and CH₄, and the formation of NH₃ below the Euro VI limit. where TWC functionality is coated on the ceramic honeycomb monolith.

FIG. 6 shows the emission of CO, NOx, and CH₄, and the formation of NH₃ below the Euro VI limit. where TWC functionality is coated on the ceramic honeycomb monolith.

FIG. 7 shows the emission of CO, NOx, and CH₄, and the formation of NH₃ below the Euro VI limit. where TWC functionality is coated on the ceramic honeycomb monolith.

FIG. 8 shows NH₃ vs. Pt/Pd in tri metallic TWC samples 2A-2C (examples 2A-2C).

FIG. 9 shows NH₃ vs. Pt/Pd with trendline (linear regression) for higher Pt/Pd in tri metallic TWC samples 2A-2C.

FIG. 10 shows NH₃ vs. Rh loading with trendline for lower Rh loading in tri metallic TWC 2A-2C.

FIG. 11 shows NH₃ vs. Pt/Pd in zoned tri metallic TWC samples 2D-2F (examples 2D-2F).

FIG. 12 shows NH₃ vs. Rh loading with trendline for lower Rh loading in zoned tri metallic TWC 2D-2F.

FIG. 13 shows NH₃ vs. Pt/Pd in Pt—Pd TWC.

### DETAILED DESCRIPTION

There are many advantages of the present invention in a broad context as well as further even more advantages aspects of the embodiments.

### TWC Functionality

In the supportive experiments described herein, the TWC component is applied to the ceramic or metallic substrate as one or more washcoat layers. The total coating amount in grams per liter washcoating (g/l) varies from 50 g/l to 400 g/l, preferably from 200 g/l to 300 g/l. Each of the aforementioned washcoat layers consists of a high surface area, thermally durable alumina based carrier, a stabilized and/or doped Ceria Zirconia mixed oxide where dopants are elements belonging to lanthanides group of the periodic table, binders are adherence promoting and/or inducing chemicals, and Pt, Pd, Rh, or any monometallic/bimetallic/trimetallic combinations thereof as a catalytically active material.

In a further embodiment, the carrier consists of aluminium oxide Al₂O₃. In some embodiments, this aluminium oxide can be doped with lanthanum oxide La₂O₃ with the fraction 1 wt %-10 wt %, preferably 1 wt %-5 wt % of the total coating amount.

In another embodiment, the carrier can consist of a mixed oxide containing Al₂O₃ and SiO₂ with SiO₂ fraction 1% wt-50% wt, preferably 15% wt-35% wt of the total coating amount. In some embodiments, the aforementioned mixed oxide can contain ZrO₂ up to 20 wt % of the total coating amount.

In a still further embodiment, the oxygen storage material consists of mixed oxides containing CeO₂, ZrO₂, La₂O₃, and one or more of the rear earth oxides. Typically, the weight fractions limits for CeO₂ are 20% wt-70% wt of the total coating amount, for ZrO₂ are 20% wt-70 wt % of the total coating amount, for La₂O₃ are 1-10% of the total coating amount, and for each of the rare earth oxides are 1% wt-10% wt of the total coating amount.

In an embodiment, boehmite is used as a binder.

In a further embodiment the TWC contains bimetallic combination of Pd and Rh. The Pd and Rh content of each of the metals in the catalyst varies from 0.01 to 5.00 wt % of the total coating amount, preferably 0.05 to 3.00 wt % of the total coating amount. In a still further embodiment, the precious metals, Pd and Rh, can be distributed so that each of them is incorporated into a separate coating layer. In some embodiments, each of the catalyst layers can contain both metals. In some embodiments, there is a combination of monometallic and bimetallic layers. In some embodiments, the total precious metal content can be distributed in separate zones. In some embodiments these zones have different combinations of coating layers.

In a further embodiment, the TWC-contains trimetallic combination of Pt, Pd and Rh. The content of each of the metals in the catalyst varies from 0.01 wt % to 5.00 wt % preferably from 0.05 wt % to 3.00 wt % of the total coating amount. In a further embodiment, the metals can be distributed so that each of them is incorporated into a separate coating layer. In some embodiments, each of the catalyst layers can contain both metals. In some embodiments, there is a combination of monometallic and bimetallic layers. In some embodiments, total metal loading can be distributed in independent zones. In some embodiments these zones may have different combinations of coating layers.

In a further embodiment, the TWC component contains a bimetallic combination of Pt and Pd. The content of each of the metals in the catalyst varies from 0.01 wt % to 5.00 wt %, preferably from 0.06 wt % to 3.00 wt % of the total coating amount. In a further embodiment, the metals can be distributed so that each of them is incorporated into a separate coating layer. In some embodiments, each of the catalyst layers can contain both metals. In some embodiments, there is a combination of monometallic and bimetallic layers. In some embodiments, total metal loading can be distributed in independent zones. In some embodiments these zones may have different combinations of coating layers.

### Sulphur and Phosphor Trapping Functionality (SPT)

In further embodiments, the SPT functionality can be applied onto ceramic or metallic substrates and one or more of the coating layers. The SPT functionality can be located in the inlet zone of the TWC or as an individual coated element located upstream from the TWC. The total coating amount varies from 50 g/l to 400 g/l of TWC, preferably from 200 g/l to 300 g/l. Each of the coating layers consists of the high surface area, thermally durable, alumina-based carrier, an adherence promoting or inducing chemical binder, and an active material in the form of a transition metal of the 4th period of the d block in the periodic table.

In further embodiments, the carrier consists of aluminium oxide Al₂O₃. In still further embodiments, this aluminium oxide can be doped with lanthanum oxide La₂O₃ with the fraction 1 wt %-10 wt %, preferably 1 wt %-5 wt %.

In a further embodiment, boehmite, ceria or mixtures of them are used as binder in a proportion of 3.0 to 40 wt % of the total coating amount.

In further embodiments, Mn is used as an active component of the SPT with the loading from 10 to 40 wt % of the total coating amount preferably from 15 to 25 wt % of the total coating amount. In another embodiment, Ce can be used as an active material with loading from 1 to 50 wt % of the total coating amount. In another embodiment, a combination of Mn and Ce can be used as an active material with the total loading from 1 to 75 wt % of the total coating amount. In yet another embodiment, the SPT with Mn, Ce, or their combination can include Pt, Pd, or their bimetallic combinations with the total loading from 0.1 to 1.0 wt % of the total coating amount.

### Selective Ammonia Oxidation Catalyst Functionality (SAOC)

In further embodiments, the SAOC coating can be applied onto ceramic or metallic substrate and one or more of the coating layers. The catalyst can either be a separate element downstream from the TWC or a zone located in the outlet part of the TWC. The total coating amounts varies from 50 g/l to 400 g/l, preferably from 100 g/l to 200 g/l. Each of the coating layer consists of a carrier composed of mesoporous material, an adherence promoting or inducing chemical binder, and active material in the form of a PGM.

In still further embodiments the carrier consists of zeolite preferably with high Silica to Alumina ratio SAR (>15) material which can be doped with copper with the fraction of 1 wt %-10 wt %, preferably 2 wt %-4 wt %.

In further embodiments the carrier consists of zeolite preferably high SAR (>15) material which can be doped with iron with the fraction of 1 wt %-10 wt %, preferably 2 wt %-4 wt %.

In still further embodiments carrier consists of zeolite, preferably high SAR (>15) material, which can be doped with Fe, Cu, Sc, Y, La, Ce, Pr, Nd, Ti, Zr and Hf. The weight fractions limits for such oxides are 1 wt %-10 Wt %, preferably 2 wt %-4 wt %. The addition of the dopant is intended to extend the thermal durability properties of the catalyst.

In a further embodiment alumina-based sol can be used as binder in a proportion of 5.0 to 15.0 wt % of the total coating amount. Here this is the amount of binder in the zeolyte layer; when Pt-layer is on the bottom the same binder is used as a Pt carrier.

In a still further embodiment PGM is used as an active material in a proportion of 0.04 to 0.125 wt %.

### System Functionality

The entire integrated system is organized so that the SPT functionality is located upstream of the TWC functionality with respect to the exhaust gas flow while SAOC functionality is located downstream. Typically, the volume of the SPT functionality is 10%-50% of the volume of TWC functionality, preferably 20%-40% of the volume of TWC functionality. Typically, the volume of the SAOC functionality is 10%-50% of the volume of TWC functionality, preferably 20%-40% of the volume of TWC functionality. In one embodiment, each functionality can be coated onto a separate substrate (ceramic or metallic). In another embodiment, SPT and TWC can be coated onto a same substrate as zones, and SAOC functionality is coated onto a separate substrate. In a further embodiment, SPT functionality can be coated onto a separate substrate while TWC and SAOC functionalities are coated onto a same substrate as zones.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way.

Any combination of the above-described elements in all possible variations thereof is encompassed by the invention unless otherwise indicated herein or otherwise clearly contradicted by context.

Recitation of ranges of values herein are merely intended to serve as a short method of referring individually to each separate value falling within the range, unless otherwise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about”, where appropriate).

All methods described herein can be performed in any suitable order unless otherwise indicated herein or otherwise clearly contradicted by context.

The terms “a” and “an” and “the” and similar referents as used in the context of describing the invention are to be construed to insert both the singular and the plural, unless otherwise indicated herein or clearly contradicted by context. Thus, “a” and “an” and “the” means at least one, or one or more.

The term “and/or” as used herein is intended to mean both alternatives as well as each of the alternatives individually. For instance, expression “xxx and/or yyy” means “the xxx and yyy; the xxx; or the yyy”, all three alternatives are subject to individual embodiments.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability and/or enforceability of such patent documents.

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter re-cited in the aspects or claims presented herein to the maximum extent permitted by applicable law.

The features disclosed in the foregoing description may, both separately and in any combination thereof, be material for realizing the invention in diverse forms thereof.

### EXPERIMENTAL

### Sulphur and Phosphor Trapping Functionality

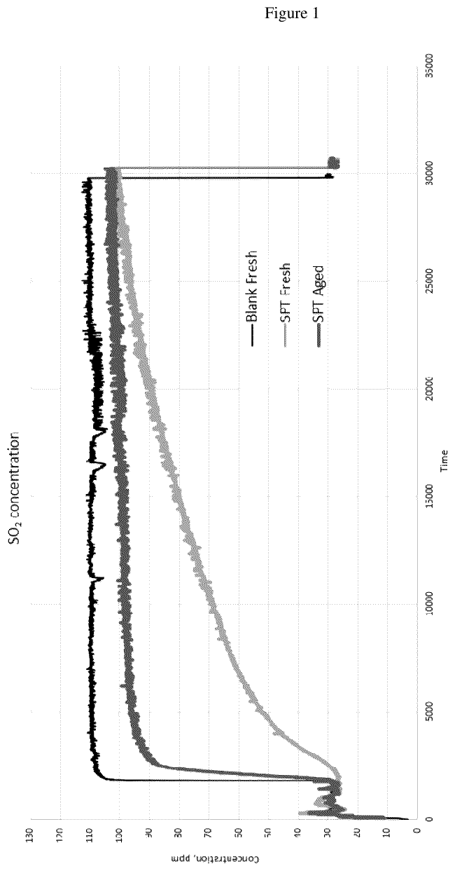

In the current example, SPT consists of two layers. The bottom layer contains combinations of highly dispersed alumina, ceria and lanthana. The top layer contains Mn oxide, alumina, ceria and lanthana. The investigation of the trapping activity was carried out in the synthetic gas bench (SGB) reactor at 450° C. in the conditions close to stoichiometric (λ=0.99) using the gaseous mixture resembling the exhaust of the NG HD vehicle with addition of 95 ppm of SO₂ (see FIG. 1). The concentration of the SO₂ was followed during the experiment by FT-IR in order to assess the SO₂ capacity of the trap.

The results show that the SPT can trap 13 wt % of SO₂ on the washcoat fresh and 5% after ageing at high temperatures. The analysis of field aged catalysts indicates that the typical S levels accumulated in a TWC during 40000-500000 km can vary significantly depending on the driving conditions, but often are within a range between 0.2 wt % and 1.2 wt % of the washcoat. Therefore, the disclosed SPT showing much higher capacity can significantly increase the durability of the presented integrated catalytic system by efficiently protecting the TWC functionality from SOx poisoning.

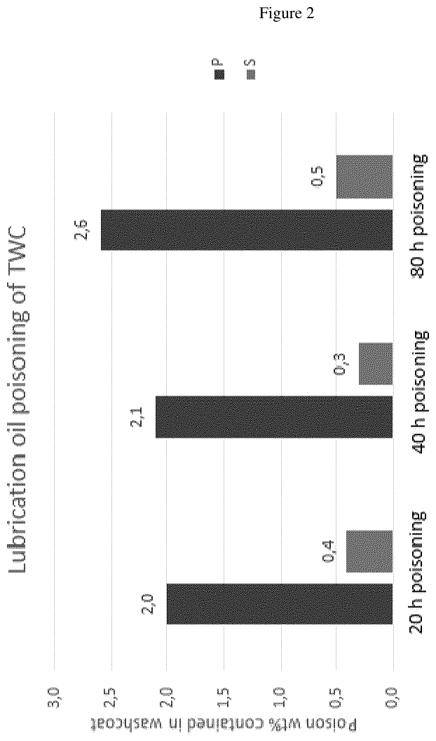

The P poisoning of the TWC usually accompanies the SOx poisoning since both poisons originate from the same source (lubrication oil). Despite the recommended limits for P concentration in the lubrication oil are tighter than for S concentration (ACEA European oil sequences 2016), the observed P content of the poisoned catalysts is normally 2-10 times higher than the corresponding S content. FIG. 2 shows the result of an accelerated poisoning protocol aimed at stimulating the cumulative P content expected from a field aged TWC.

The reason for this is the irreversible binding of P with the high surface area components of the washcoat, especially alumina. Since the disclosed SPT also contains alumina as a carrier, it is claimed that it will be active towards P poisoning. Based on the S trapping activity, it is anticipated that the SPT will trap 25 wt % of phosphorus.

In all zoned examples below the inlet zone is equal in length to the outlet zone.

In all examples below the ratio between Pt/Pd/Rh follows that order, thus, for instance 0:17:1 means 0 Pt, 17 Pd and 1 Rh.

### TWC Functionality

### Example 1 A (Pd/Rh Bimetallic)

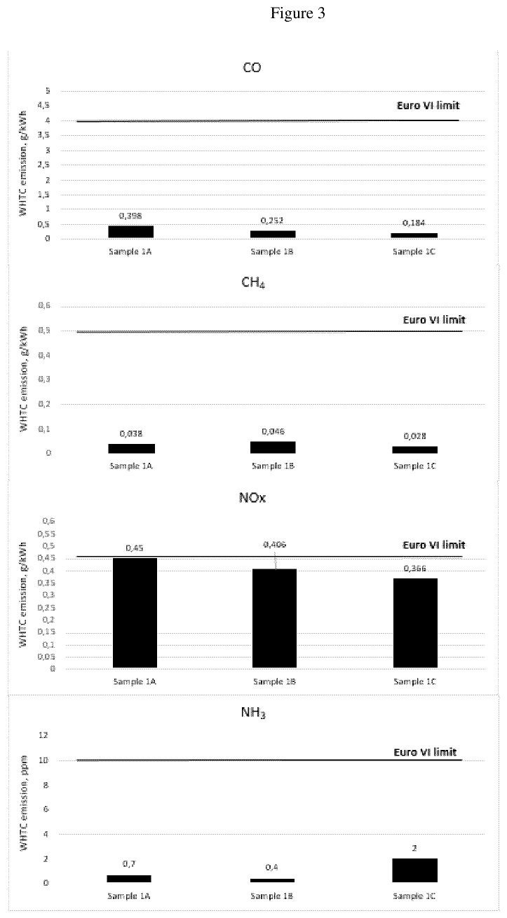

In the current example, TWC functionality is zone coated on the ceramic honeycomb monolith with an average PGM loading of 4,944 g/lit (throughout the description g/lit is interchangeable with g/l and g/liter) and a ratio of 0:17:1. The front zone has 6,356 g/lit PGM loading and a ratio of 0:13:1. The rear zone has 3,531 g/lit PGM loading and a ratio of 0:40:1. The sample was tested on the CNG engine over the WHTC cycle after oven ageing at 950° C. for 24 hours. It demonstrates the emission of CO, NOx, and CH₄, and the formation of NH₃ below the Euro VI limit for the CNG HD vehicles, see FIG. 3.

### Example 1 B (Pd/Rh Bimetallic)

In the current example, TWC functionality is zone coated on the ceramic honeycomb monolith with an average loading of 4,238 g/lit and a ratio of 0:15:1. The front zone has 4,216 g/lit PGM loading and a ratio of 0:10:1. The rear zone has 4,258 g/lit PGM loading and a ratio of 0:28:1. Loading was decreased compared to the example 1A and the zones are containing more Rh compared to example one. The sample was tested on the CNG engine over the WHTC cycle after oven ageing at 950° C. for 24 hours. Despite the total loading decrease, emissions for CO and NOx and NH₃ formation have improved compared to the example 1A, only the emission for CH₄ has slightly increased, but is still well below the limit value, see FIG. 3.

### Example 1 C (Pd/Rh Bimetallic)

In the current example, TWC functionality is zoned coated on the ceramic honeycomb with an average loading of 5,121 g/lit and a ratio of 0:24:1. The front zone has 5,121 g/lit PGM loading and a ratio of 0:12:1. The rear zone has 5,121 g/lit PGM loading and a ratio of 0:1:0. In this example the total loading is slightly higher, but contains less Rh, than in examples 1A and 1B, and PGM are distributed in a different manner respect to example 1A and 1 B. The sample was tested on the CNG engine over the WHTC cycle after oven ageing at 950° C. for 24 hours. Results indicates clear improvement in all CO, CH₄ and NOx emissions compared to the example 1 A and B, only NH₃ formation is higher, but still well under the limit value, see FIG. 3.

### Example 1 D (Pd/Rh Bimetallic)

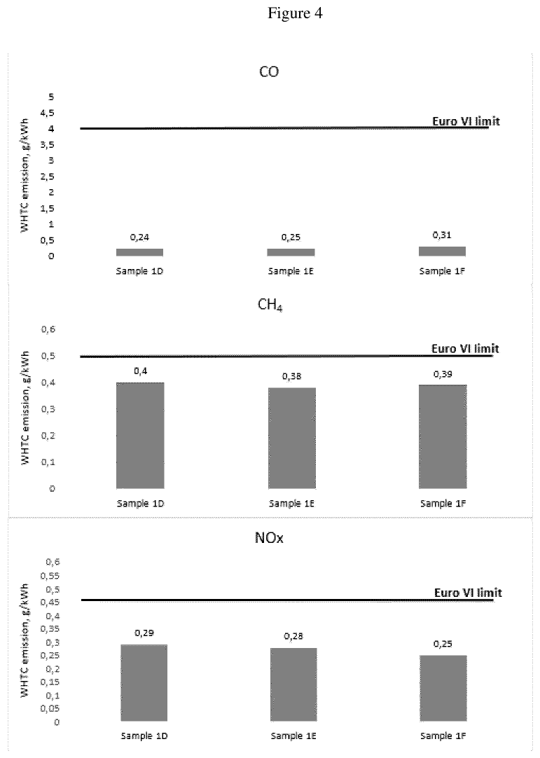

In the current example, TWC functionality is coated on the ceramic honeycomb monolith and organized in two layers with an average loading of 5,297 g/lit and a ratio of 0:16:1 (not zoned). The sample was tested on the CNG engine over the WHTC cycle. It shows the emission of CO, NOx and CH₄ below the Euro VI limit for the CNG HD vehicles, FIG. 4.

### Example 1 E (Pd/Rh Bimetallic)

In the current example, TWC functionality is coated on the ceramic honeycomb monolith and organized in two layers. The average loading was 5,297 g/lit and a ratio of 0:29:1 (not zoned). The sample was tested on the CNG engine over the WHTC cycle. It demonstrates the emission of CO, NOx, and CH₄ below the Euro VI limit for the CNG HD vehicles, see FIG. 4. PGMs organized with different Pd:Rh ratio improved slightly the emissions for CO, NOx and CH₄ compared to the example 1D.

### Example 1 F (Pd/Rh Bimetallic)

In the current example, TWC functionality is zone coated on the ceramic honeycomb monolith with an average loading of 5,202 g/lit and a ratio of 0:14:1. The front zone has 5,226 g/lit PGM loading and a ratio of 0:9,4:1. The rear zone has 5,173 g/lit PGM loading and a ratio of 0:26,2:1. The sample was tested on the CNG engine over the WHTC cycle. It demonstrates the emission of CO, NOx and CH₄ below the Euro VI limit for the CNG HD vehicles, see FIG. 4. Zoned structure with higher Rh content clearly improved the performance for NOx, CH₄ was about the same level as for examples 1D and E; CO was slightly higher but still very low level.

### Example 2 A (Pt/Pd/Rh) Trimetallic)

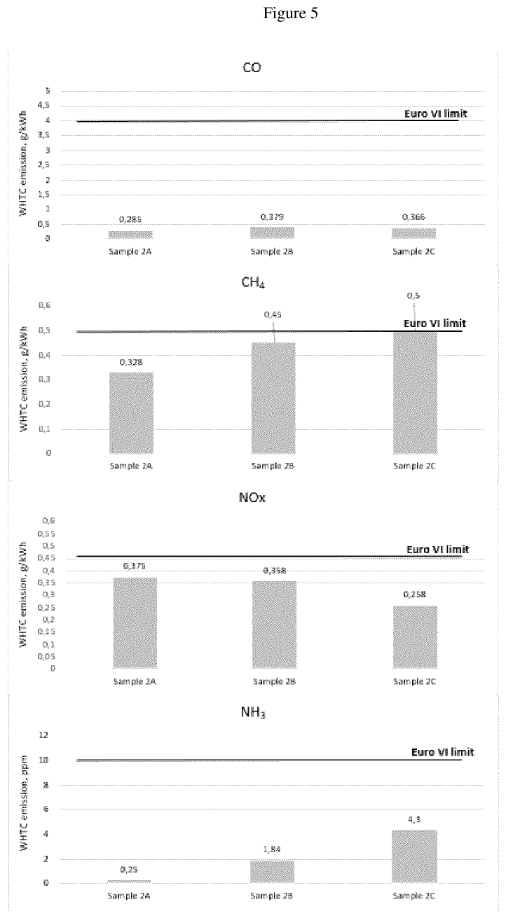

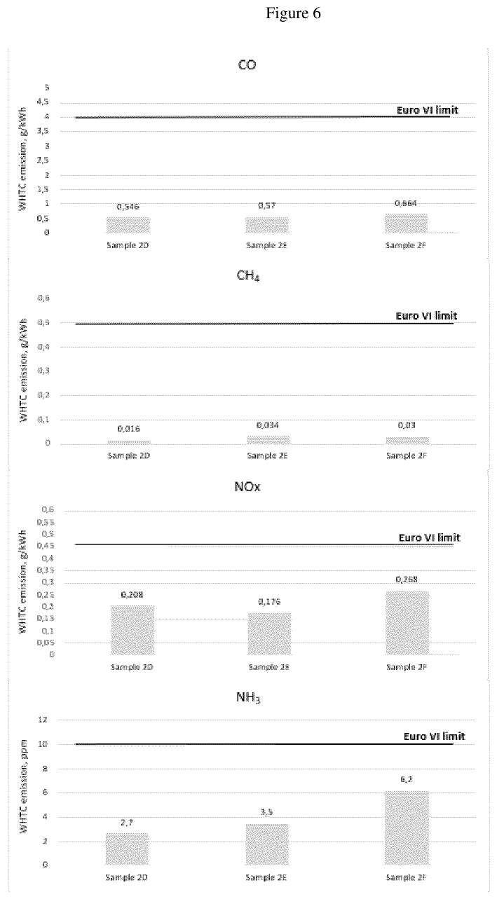

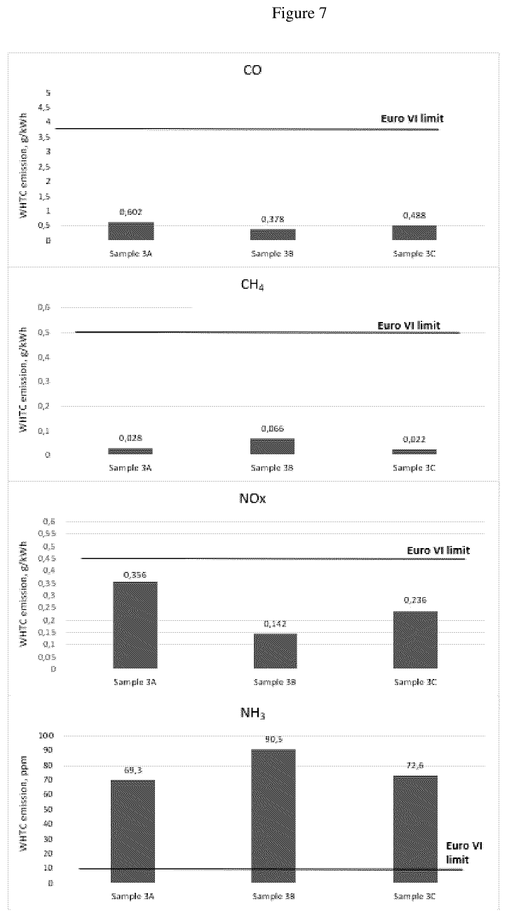

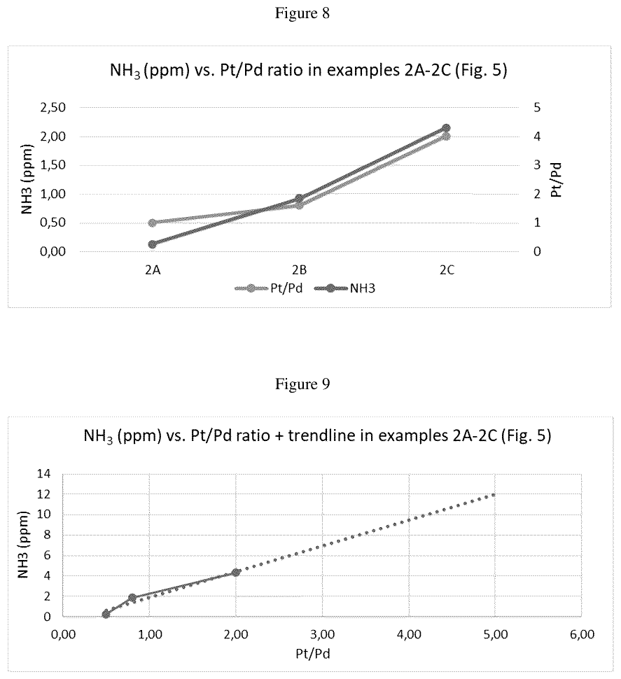

In the current example, TWC functionality is coated on the ceramic honeycomb monolith and organized in two layers with an average loading of 3,531 g/lit and a ratio of 3:6:1 (not zoned). The sample was tested on the CNG engine over the WHTC cycle. The sample shows that the emission of CO, NOx, and CH₄, and the formation of NH₃ below the Euro VI limit for the CNG HD vehicles, see FIG. 5.

### Example 2 B (Pt/Pd/Rh) Trimetallic)

In the current example, TWC functionality is coated on the ceramic honeycomb monolith and organized in two layers with an average loading of 2.469 g/lit and a ratio of 4:5:1 (not zoned). The sample was tested on the CNG engine over the WHTC cycle. The sample shows that the emission of CO, NOx, and CH₄, and the formation of NH₃ below the Euro VI limit for the CNG HD vehicles, see FIG. 5.

### Example 2 C (Pt/Pd/Rh) Trimetallic)

In the current example, TWC functionality is coated on the ceramic honeycomb monolith and organized in two layers with an average loading of 1,432 g/lit and a ratio of 6:3:1 (not zoned). The sample was tested on the CNG engine over the WHTC cycle. The sample shows that the emission of CO, NOx, and CH₄, and the formation of NH₃ below the Euro VI limit for the CNG HD vehicles, see FIG. 5.

### Example 2 D (Pt/Pd/Rh Trimetallic)

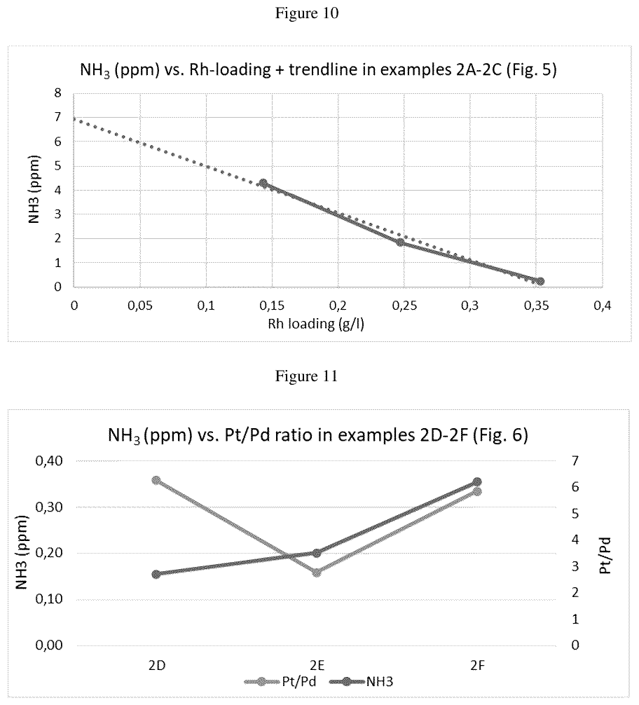

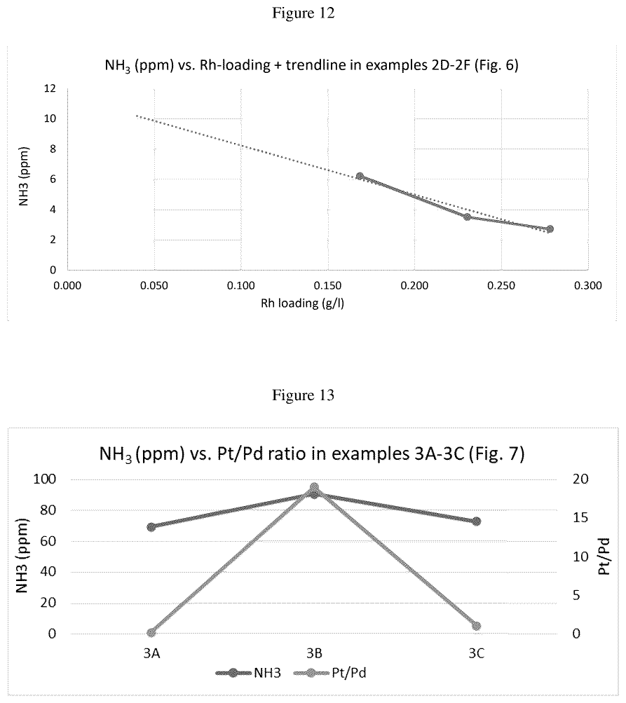

In the current example, TWC functionality is zoned coated on the ceramic honeycomb monolith and organized in two zones with two layers each, with an average loading of 5.561 g/lit and a ratio of 5:14:1. The front zone has 7,062 g/lit PGM loading and a ratio of 6:9:1. The rear zone has 4,061 g/lit PGM loading and a ratio of 0:35:1. The sample was tested on the CNG engine over the WHTC cycle. It shows the emission of CO, NOx, and CH₄, and the formation of NH₃ below the Euro VI limit for the CNG HD vehicles, see FIG. 6.

### Example 2 E (Pt/Pd/Rh Trimetallic)

In the current example, TWC functionality is zoned coated on the ceramic honeycomb monolith and organized in two zones with two layers each, with an average loading of 5.297 g/lit and a ratio of 3:17:1. The front zone has 7,062 g/lit PGM loading and a ratio of 4:13:1. The rear zone has 3,531 g/lit PGM loading and a ratio of 0:29:1. The sample was tested on the CNG engine over the WHTC cycle. It shows the emission of CO, NOx, and CH₄, and the formation of NH₃ below the Euro VI limit for the CNG HD vehicles, see FIG. 6.

### Example 2 F (Pt/Pd/Rh Trimetallic)

In the current example, TWC functionality is zoned coated on the ceramic honeycomb monolith and organized in two zones with two layers each, with an average loading of 5.561 g/lit and a ratio of 8:24:1. The front zone has 7,062 g/lit PGM loading and a ratio of 12:18:1. The rear zone has 4,061 g/lit PGM loading and a ratio of 0:35:1. The sample was tested on the CNG engine over the WHTC cycle. It shows the emission of CO, NOx, and CH₄, and the formation of NH₃ below the Euro VI limit for the CNG HD vehicles, see FIG. 6.

### Example 3 A (Pt/Pd Bimetallic)

In the current example, TWC functionality is coated on the ceramic honeycomb monolith and organized in two layers with an average loading of 5,297 g/lit and a ratio of 1:6:0 (not zoned). The sample was tested on the CNG engine over the WHTC cycle after oven ageing at 950° C. for 24 hours. It demonstrates the emission of CO, NOx, and CH₄ below the Euro VI limit for the CNG HD vehicles while the emission of NH₃ is above the Euro VI limit, see FIG. 7. The high NH₃ emission of the Pt/Pd bimetallic TWC will be reduced to the level below the Euro VI limit by means of SAOC.

### Example 3 B (Pt/Pd Bimetallic)

In the current example, TWC functionality is coated on the ceramic honeycomb monolith and organized in two layers with an average loading of 5.297 g/lit and a ratio of 19:1:0 (not zoned). The sample was tested on the CNG engine over the WHTC cycle after oven ageing at 950° C. for 24 hours. It demonstrates the emission of CO, NOx, and CH₄ below the Euro VI limit for the CNG HD vehicles while the emission of NH₃ is above the Euro VI limit, see FIG. 7. The high NH₃ emission of the Pt/Pd bimetallic TWC will be reduced to the level below the Euro VI limit by means of SAOC.

### Example 3 C (Pt/Pd Bimetallic)

In the current example, TWC functionality is zoned coated on the ceramic honeycomb monolith and organized in two zones with two layers each, with an average loading of 5.297 g/lit and a ratio of 1:1:0. The front zone has 5,297 g/lit PGM loading and a ratio of 19:1:0. The rear zone has 5,297 g/lit PGM loading and a ratio of 1:6:0. The sample was tested on the CNG engine over the WHTC cycle after oven ageing at 950° C. for 24 hours. It demonstrates the emission of CO, NOx, and CH₄ below the Euro VI limit for the CNG HD vehicles while the emission of NH₃ is above the Euro VI limit, see FIG. 7. The high NH₃ emission of the Pt/Pd bimetallic TWC will be reduced to the level below the Euro VI limit by means of SAOC.

### SAOC Functionality

### Examples 4 A-4 E

In the first example (4A) SAOC consist of two layers: a mesoporous material (SAR>15) layer on top (140 g/l) and a thin oxidation layer including Pt, 0.07 g/l on bottom (20 g/l). In the second example (4B) the active oxidation agent is in a zone in the rear part of the element (20 g/l) with the same Pt loading as in the example 4A. The third example (4C) SAOC consists of two layers: different mesoporous material than in examples 4A & 4B was coated on the first layer on top (140 g/l) and a thin oxidation layer with the Pt loading (0.07 g/l) on bottom (20 g/l). The fourth example (4D) SAOC consists of single layer concept (140 g/l) with a third mesoporous material (SAR>15) without any Pt layer or stripe. The fifth sample (4E) consists of the same mesoporous material (SAR>15) on bottom (120 g/l) as in the sample 4D with 3 wt-% Zr as oxide and a thin oxidation layer with the Pt loading (0.07 g/l) on bottom (20 g/l). The samples were tested in LD engine dyno over New European Driving Cycle (NEDC) cycle and ammonia formation was measured over the cycle. The ammonia formation of the different SAOC samples were compared to a sample without any coating in SAOC (uncoated SAOC). Downstream in the exhaust line a thermally aged (1000° C.×10 h) Pd—Rh TWC (example 1D Pt:Pd:Rh 0:16.1 5.297 g/l) is placed to produce ammonia. The SAOC samples were tested as fresh and after HT-700° C./20 h ageing. Results demonstrate 60-94% decrease of the average ammonia level over the test cycle compared to the system without any SAOC coating, table 1. Hydrothermal ageing at 700° C. seems to have only small effect on the ammonia oxidation ability of the tested SAOC samples. When comparing the efficiency of the samples, it is possible to see that the sample 4E is giving the lowest ammonia level within the Pt containing samples. The sample 4D can decrease the ammonia level down without Pt even after ageing. Emissions over the NEDC cycle were measured, too, to see the effect of SAOCs on the TWC functionality, table 2. The relative emissions for CO and THC are very similar for TWC+SAOC compared to TWC+uncoated SAOC indicating minor effect of the SAOC on the oxidation of CO and HC's. NOx emission is improved (relative emission lower than for TWC+empty SAOC) with all tested SAOC's indicating better NOx conversion, which is assisted by the SAOC. The lowest NOx was achieved with SAOC sample 4D as fresh and after HT-700° C./20 h ageing.

TABLE 1
Average ammonia (NH₃) formation over
the NEDC cycle tested in LD vehicle.

| | Average NH₃ over NEDC, ppm |
|---|---|
| TWC aged + uncoated SAOC | 30.2 |
| TWC aged + Sample 4 A - Fresh | 7.3 |
| TWC aged + Sample 4 A - Aged | 9.7 |
| TWC aged + Sample 4 B - Fresh | 11.5 |
| TWC aged + Sample 4 B - Aged | 11 |
| TWC aged + Sample 4 C - Fresh | 3.1 |
| TWC aged + Sample 4 C - Aged | 1.7 |
| TWC aged + Sample 4 D - Fresh | 2.5 |
| TWC aged + Sample 4 D - Aged | 5.5 |
| TWC aged + Sample 4 E - Fresh | 0.7 |
| TWC aged + Sample 4 E - Aged | 0.6 |

TABLE 2
Relative emission over the NEDC cycle tested
in LD vehicle compared to TWC + uncoated SAOC

| | CO | THC | NOx |
|---|---|---|---|
| TWC aged + uncoated SAOC | 1 | 1 | 1 |
| TWC aged + Sample 4 A - Fresh | 1 | 0.96 | 0.87 |
| TWC aged + Sample 4 A - Aged | 1.1 | 0.98 | 0.8 |
| TWC aged + Sample 4 B - Fresh | 1.06 | 0.96 | 0.67 |
| TWC aged + Sample 4 B - Aged | 1.02 | 0.96 | 0.8 |
| TWC aged + Sample 4 C - Fresh | 0.88 | 0.95 | 0.67 |
| TWC aged + Sample 4 C - Aged | 0.93 | 1.01 | 0.96 |
| TWC aged + Sample 4 D - Fresh | 0.95 | 1 | 0.63 |
| TWC aged + Sample 4 D - Aged | 0.96 | 0.99 | 0.70 |
| TWC aged + Sample 4 E - Fresh | 1.02 | 0.96 | 0.82 |
| TWC aged + Sample 4 E - Aged | 1.04 | 0.98 | 0.78 |

Table 2 additionally supports the selective character of the SAOC which is evidenced by the decrease of the relative NOx values. If reactions were to be not selective the relative values would be above 1, as a result of the conversion of ammonia to NOx.

### Further Conclusions Based on the Above Experiments.

The SPT should be separated from the TWC to ensure both Sulfur and Phosphorus trapping and optimized TWC functionality, which means that the SPT is on a separate first substrate and has no overlap with TWC on the second separate substrate. This means the SPT is specified to collect sulfur and phosphorus separately from TWC to protect TWC performance from poisoning. If trapping functionality is a part of TWC it will interference the TWC performance.

The SAOC is selectively converting ammonia to N₂ by the specified coating which is dedicated not only to oxidizing NH₃ but converting it selectively to N₂. If SAOC is not selective it converts ammonia (NH₃) to NOx, which is not the preferred function.

As Rh is the most expensive active PGM and Pd more expensive than Pt, the TWC cost can be reduced when decreasing Rh amount and replacing some Pd with Pt in TWC; then, the ammonia (NH₃) formation can be a problem.

SAOC function is needed when Pd—Rh based TWC is changed to high Pt containing tri-metallic or even to Pt—Pd based TWC.

Dedicated formulation with SAOC is needed to keep ammonia formation under the limit values, therefore selective ammonium oxidation is needed to avoid oxidation back to NOx. As a consequence, when using SAOC, NH₃ formation after TWC and SAOC must be <NH₃ formation after TWC alone; and at the same time to proof the selectivity the ratio:

$$\frac{NOx after TWC + S A O C}{NOx after TWC alone} \leq 1$$

Decreasing Rh amount connected to increasing Pt/Pd ratio (decreased Pd loading, while Pt loading is kept the same; therefore, total loading is decreasing, as well) in tri metallic TWC significantly decreases the cost of TWC, at the same time this causes higher ammonia formation.

This is seen in FIG. 5 (examples 2A-2C) where the results of tri-metallic TWC catalysts were presented. The dependence of the Rh loading and Pt/Pd ratio to NH₃ formation is seen in the FIGS. 8-10. In the zoned samples where tri metallic TWC is placed in the front zone (samples 2D-2F and FIG. 6) the increasing ammonia formation is more related to the decreasing Rh amount than the Pt/Pd ratio (seen in the FIGS. 11 and 12): NH₃ formation increases when the Rh loading decreases.

Based on these results we can specify the maximum Pt/Pd and minimum Rh values in a tri metallic concept: Pt/Pd should be equal to or <4 and Rh loading equal to or >0.05 g/l for a maximum of 10 ppm NH₃ formation over WHTC. For the Pt—Pd TWC concept without Rh the SAOC is essential. This also, means that a further aspect as described herein is a TWC comprising a specified Pt/Pd ratio together with a specified wash coating with Rh. When this specified TWC is used the ammonium can be kept lower and in particular lower than 10 ppm during operation of a stoichiometrically operated engine.

As seen in FIG. 8 Ammonia (NH₃) formation is increased when Pt/Pd ratio increases in the samples 2A-2C.

As seen in FIG. 9 NH₃ vs. Pt/Pd with trendline (linear regression) for higher Pt/Pd in tri metallic TWC samples 2A-2C.

As seen in FIG. 10 NH₃ vs. Rh loading with trendline for lower Rh loading in tri metallic TWC 2A-2C.

Ammonia (NH₃) formation achieves 10 ppm limit value when Pt/Pd ratio goes up to about 4 in the samples 2A-2C.

Ammonia (NH₃) formation increases within the Rh loading decrease in the samples 2A-2C.

Based on the results for the samples 2A-2C (FIG. 5) we can extrapolate (make a trend line using linear regression) the ammonia formation to the lower Rh-loading than in the samples and similarly Pt/Pd ratio to higher ratios than in the samples. The estimated limit value for max 10 ppm NH₃ formation is about 4 to Pt/Pd ratio and min Rh loading of about 0.05 g/l.

In FIG. 11 is seen NH₃ vs. Pt/Pd in zoned tri metallic TWC samples 2D-2F.

As shown in FIG. 12 Ammonia (NH₃) formation increases within the Rh loading decrease in the samples 2D-2F.

For zoned samples 2D-2F (FIG. 6) Pt/Pd ratio do not to affect the ammonia formation level significantly but Rh-loading does: similar extrapolation to lower Rh loadings than in the samples gives for max 10 ppm NH₃ formation min Rh loading about 0.05-0.1 g/l.

If Rh is omitted and TWC consists of Pt—Pd technology, high ammonia formation is inevitable as seen in the results in examples 3A-3C in FIG. 7, then the SAOC need is obvious. In Rh free TWC Pt/Pd ratio is not affecting much about the NH₃ formation: it is at high level for all the samples in examples 3A-3C (visualized also in the FIG. 13).

1-16. (canceled)

17. A multifunctional catalyst system for reducing harmful exhaust gas emissions from an exhaust gas stream of a stoichiometrically operated engine, the system comprising:
a) a coating comprising a sulphur oxide and phosphorus trap (SPT) on a first substrate,
b) a three-way catalyst (TWC) on a second substrate, and
c) a selective ammonia oxidation catalyst (SAOC) on a third substrate;
wherein the first and second substrate are different substrates avoiding any overlap between the SPT and the TWC,
wherein the SPT is positioned upstream from the TWC while the SAOC is positioned downstream from the TWC and the multifunctional catalyst system is adapted for positioning downstream from the stoichiometrically operated engine, which multifunctional catalyst system is adapted to be in fluid communication with the exhaust gas stream,
wherein the SPT is present in an amount of 10-50 vol % of total TWC volume,
wherein the SAOC is present in an amount of 10-50 vol % of total TWC volume.

18. The catalyst system according to claim 17, wherein i) the first, second and third substrate are different substrates, or ii) the second and third substrate are the same substrate, and the first substrate is different.

19. The catalyst system according to claim 17, wherein the SPT is present in an amount of 20-40 vol % of the total TWC volume.

20. The catalyst system according to claim 17, wherein the SAOC is present in an amount of 20-40 vol % of the total TWC volume.

21. The catalyst system according to claim 17, wherein the TWC comprises at least one of Pt, Pd, and Rh, wherein a total coating amount in grams per liter washcoating (g/l) is from 50 g/l to 400 g/l.

22. The catalyst system according to claim 17, wherein the TWC comprises a Pt/Pd ratio (wt %/wt %) of lower than 6.

23. The catalyst system according to claim 17, wherein the TWC comprises a Pt/Pd ratio (wt %/wt %) of 4 or lower than 4 combined with minimum 0.05 g Rh/liter washcoat.

24. The catalyst system according to claim 17, wherein the SPT comprises at least one of Cu, Mn, and Ce, wherein a total coating amount in grams per liter washcoating (g/l) is from 50 g/l to 400 g/l.

25. The catalyst system according to claim 24, wherein the SPT further comprises at least one of Pt and Pd.

26. The catalyst system according to claim 17, wherein the SAOC comprises at least one of Fe, Cu, Sc, Y, La, Ce, Pr, Nd, Ti, Zr and Hf.

27. The catalyst system according to claim 26, wherein SAOC is selectively converting ammonia to N₂, keeping ammonium below 10 ppm after SAOC treatment.

28. The catalyst system according to claim 27, wherein the SAOC comprises at least one of Pt and Pd.

29. The catalyst system according to claim 17, wherein the first, second and/or third substrate is selected from a ceramic or metallic honeycomb monolith.

30. The catalyst system according to claim 17, wherein the stoichiometrically operated engine is a natural gas or biogas engine.

31. A method to reduce harmful exhaust gas emission from a stoichiometrically operated engine comprising positioning the multifunctional catalyst system according to claim 17 downstream from the stoichiometrically operated engine.

32. The method of claim 31, wherein the stoichiometrically operated engine is a natural gas or biogas engine.
